(19) United States
(12) Patent Application Publication
(10) Pub. No.: US 2017/0178194 A1
(43) Pub. Date: Jun. 22, 2017

(54) INFORMATION PROVISION SYSTEM

(71) Applicant: Shinji NAGASAKA, Okazaki-shi (JP)

(72) Inventors: Shinji NAGASAKA, Okazaki-shi (JP); Mineyuki IKUTA, Hekinan-shi (JP)

(21) Appl. No.: 15/446,327

(22) Filed: Mar. 1, 2017

Related U.S. Application Data
(63) Continuation of application No. PCT/JP2015/074397, filed on Aug. 28, 2015.

(30) Foreign Application Priority Data
Sep. 2, 2014 (JP) 2014-178037

(51) Int. Cl. G06Q 30/02

(52) U.S. Cl. CPC G06Q 30/0267

(57) ABSTRACT

Advertisement information is effectively provided to a portable terminal such as a smart phone via a network. An information provision system comprises a management server that stores video data and a portable terminal. The portable terminal obtains the video data from the management server as appropriate via a network and save it thereon. When a user performs a startup operation for restoring the portable terminal from a sleep state, the portable terminal plays the video by giving priority thereto over a startup screen. A playback history of videos is reported to the management server, and the user receives privileges based on the playback history. In this manner, information is effectively provided though videos while the user is watching the screen during the startup operation. In addition, the effectiveness of the information provision is improved as the user has motivation to view videos because of the privileges to be given.

### CLAIM OF PRIORITY

This application is a Continuation of International Patent Application No. PCT/JP2015/074397, filed on Aug. 28, 2015, which claims priority to Japanese Patent Application No. 2014-178037, filed on Sep. 2, 2014, each of which is hereby incorporated by reference.

### BACKGROUND OF THE INVENTION

1. Field of the Invention

The present invention relates to an information provision system for providing advertisements and other types of information via a network to terminals such as a personal computer, a smart phone, a tablet, and a mobile phone.

2. Description of the Related Art

The terminals such as a personal computer, a smart phone, a tablet, and a mobile phone are widely used for searching and viewing the advertisements and other types of information via the network such as the internet. These types of information are provided not only when a user searches them from the terminal but also in a format of an advertisement partially displayed on a web page or the like. They are provided regardless of intention of the user as automatic delivery from various servers installed on the network to the terminals via an e-mail or a social network system in some cases. In a mode in which the information is provided regardless of intention of the user, how to increase a possibility of a user to view the provided information is a problem. As those methods, such a method is employed that preferences of the user is analyzed on the basis of the information having been viewed by the user, a use history of online shopping and the like, and the information mainly in a field in which the user is interested is provided, for example.

As ideas relating to timing of providing the information to the user, Japanese Patent Laid-Open No. 2007-193627 and Japanese Patent Laid-Open No. 2005-6185 disclose technologies of playing back image data recorded in advance in a hard disk in a hard disk recorder which records TV programs and the like in the hard disk by using time until the system starts up since it was turned on.

### SUMMARY OF INVENTION

However, terminals are turned off less frequently than the hard disk recorder, and if the time point when they are turned on is utilized, timing when the information can be provided is limited. Moreover, among other terminals, in the case of a portable terminal such as a smart phone, the user uses often it while moving or the like and the user does not necessarily pay attention to a screen after the terminals are turned on.

The present invention was made in view of such a problem and has an object of providing a technology of increasing a possibility that the information is viewed by the user when the information is provided to the terminal.

One embodiment of the present invention is configured as an information provision system comprising a terminal used by a user and a management server for providing information to the terminal via a network, wherein the management server comprises a video database for storing video data for providing the information in a video (which may also be referred to as a motion video or moving image) or access information for accessing the video data on the network. The terminal comprise (a) a detecting unit for detecting a startup operation for starting up the terminal from a sleep state, (b) a video management unit for obtaining, prior to the startup operation, the video data in advance via the management server, (c) a video storage unit for storing the obtained video data, (d) a startup screen display unit for displaying a startup screen on the terminal in accordance with the startup operation, and (e) a video playback unit for playing back the video data stored in the video storage unit in preference to an operation of the startup screen display unit when the startup operation is detected.

The terminals include both of those which cannot be carried such as a desktop personal computer and those which can be carried such as a smart phone. Moreover, not only these information devices but also various devices connectable to the network and having a screen for displaying information such as a display attached to a home electric appliance, for example, can be applied.

The network may be a wide range one such as the internet or may be those in a limited region such as an intranet. Communication via the network may be wireless and wired.

For the video provided by one embodiment of the present invention, various contents such as advertisements, news, weather forecasts, tourist information, fortune telling, event information and the like can be used.

The startup operation for starting up the terminal from the sleep state includes inputs of a password, a passcode, a pass pattern or the like, operation of screen display switch and other physical switches or the like, for example. However, the startup operation does not include a turning-on operation.

The management server may store the video data itself or may store access information which can specify location of the video data such as URL on the network.

According to one embodiment of the present invention, when the startup operation of the terminal is detected, the video data stored in advance is played back in preference to display of an original startup screen. The priority can include a mode in which the display of the startup screen is stopped, and the video data is played back and a mode in which the video data is played back on a front of the startup screen.

The user of the terminal turns it off relatively scarcely but brings it into the sleep state very often. Since the user starts up the terminal from the sleep state when the user wants to use the terminal, it is likely that the user gazes at the screen of the terminal after performing the startup operation. In one embodiment of the present invention, since the video data prepared in advance is played back by utilizing such timing, it is very likely that the played-back video is viewed by the user.

Moreover, since an OS (Operating System) is activated in the sleep state, an application can be relatively easily activated unlike at turning-on in the terminal. Therefore, one embodiment of the present invention also has an advantage that the system can be realized relatively easily by setting timing of playing back the video data not at the turning-on but at startup from the sleep state.

Moreover, in one embodiment of the present invention, since the video data to be played back is provided via the management server, new videos can be provided as appropriate, and a possibility that the user is fed up with the videos can be suppressed.

Since this video data has been obtained prior to the startup operation, it is not necessary to download the video data in the startup operation or the like and there is an advantage that the video data can be played back rapidly. The timing of obtaining the video data may be before the terminal is brought into the sleep state or may be between the sleep states.

In one embodiment of the present invention, the terminal may be a portable terminal that can be carried by a user. The portable terminals include various devices which are portable and connectable to the network, such as a smart phone, a tablet, a mobile phone and a laptop personal computer. The user of the portable terminal brings the device into the sleep state instead of turning-off while it is not in use most of the time. Therefore, the present invention is particularly useful for the portable terminals.

In one embodiment of the present invention, it is preferable that a video playback unit for playing back the video data is protected so that its function is not stopped, removed or deleted by the user. When the video playback unit is realized in a software manner by an application, for example, protection can be realized by a method of excluding the video playback unit from targets of an uninstalling operation of normal applications, a method requiring an input of a password or the like for uninstalling and the like.

In one embodiment of the present invention, the video management unit may obtain the video when at least one of conditions is satisfied that there is no more video data which has not been played back among the video data stored in the video storage unit and that there is no more video data within a view deadline.

While there is non-played-back video data in the video data obtained in the video storage unit, new video can be provided to the user by using the non-played-back video data without obtaining the new video data, for example. On the other hand, when there is no more non-played-back video data, the new video data is preferably obtained in order to avoid distraction of the user.

There is some video data whose contents have meanings only in a limited period of time such as weather forecasts, fortune telling, event information and the like. For the video data with a limited viewing deadline, it is preferable that the video data is deleted and the new video data is obtained when the viewing deadline expires.

According to the configuration above, since the video data is obtained by considering these conditions, the videos can be provided efficiently, while distraction of the user is suppressed. In the aforementioned two conditions, both may be considered or only either one of them may be considered. Moreover, this mode can be similarly applied whether the video storage unit can store only one piece of or plural pieces of the video data.

As a method of providing the new videos to the user, a method of obtaining the video data in a relatively short cycle whether the user has viewed it or not can be considered. However, there is a concern that the obtainment if the video data is performed excessively. On the other hand, according to the configuration above, there is an advantage that the new videos can be provided to the user while such excessive obtainment is suppressed.

However, the timing of obtaining the video data in one embodiment of the present invention can be set variously regardless of this mode. For example, the video data may be obtained periodically or may be obtained at timing when a predetermined number of pieces of the video data stored in the video storage unit have been viewed.

In one embodiment of the present invention, the terminal may comprise a playback history reporting unit for reporting a history of playback of the videos to the management server. The the management server may comprise: a viewing history management unit for managing a viewing history of viewing the video by the terminal on the basis of the report; and a privilege management unit for determining a privilege given to the user of the terminal on the basis of the viewing history.

According to the aforementioned mode, giving of the privilege to the user makes motivation to view the video, whereby a possibility of viewing the video by the user can be further increased.

The privileges can include discount or exemption of a usage fee of the terminal, provision of coupons or points which can be used in various online shops or actual shops and the like. These privileges may be given with uniform contents when a predetermined number or predetermined time of viewing of videos by the user is exceeded or the contents of the privileges may be changed in accordance with the number or time of viewing, for example.

In one embodiment of the present invention, whether the aforementioned configuration of managing the viewing history of the videos is employed or not, the system may comprise: (a) a selection screen display unit for, after playback of video by the video playback unit is finished, displaying a selection screen prompting selection of display of image information different from the videos in preference to an operation of the startup screen display unit; and (b) an image information display unit for displaying the image information selected in the selection screen.

By configuring as above, more diversified information can be provided to the user together with the videos. Moreover, since what is displayed after playback of the video is the selection screen for selecting whether or not the image information is to be displayed, the user can select whether or not the image information is to be viewed by considering the user's own interest or allowance of time. Therefore, according to the aforementioned mode, user can avoid forced viewing of many pieces of image information, and diversified information can be provided while lowering of convenience of the information provision system is avoided.

The selection screen may be a screen not only for selection of whether or not to display the image information but if image information is to be displayed, the screen may be configured such that the contents can be selected. For example, viewable image information may be directly selected in a format of thumbnails or icons, or genres of the image information such as sports, fashion and the like may be selected. The contents or the genres of the image information selected by the user may be reflected in selection of the videos or image information at the subsequent startup, for example.

When the display of the selection screen is realized in the software manner, a method of starting up an application for displaying such a screen may be employed or a method of displaying shortcuts or icons for starting up the application for displaying the screen or the like may be employed.

The image information displayed in the aforementioned mode may be either one of videos and still images. Moreover, it may be any one of images stored in advance in the terminal, images obtained in advance via the network or the like, and images obtained via the network and the like upon instruction of display of the images. As the contents of the image information, various contents such as advertisements, news, weather forecasts, tourist information, fortune telling, event information and the like can be used.

When the image information display unit is included as above, the selection screen display unit may be configured not to operate when a predetermined number which is one or more pieces of the image information is displayed within a predetermined period.

By configuring as above, the user's motivation to view the image information can be strengthened. That is, according to the aforementioned mode, by having viewed the predetermined number of pieces of the image information within the predetermined period, the startup screen is displayed rapidly if only the user views the videos at the startup.

The predetermined period and the predetermined number can be set arbitrarily. They may be set to be one type per day, for example. In this case, if the user allows the image information to be displayed at any timing in a day, the startup screen is displayed rapidly after playback of the videos is finished without displaying the screen for selecting viewing of the image information after that.

On the contrary, if the user skips viewing of the image information many times, a degree of forcing the user to view the image information may be gradually increased. A method of making an operation of skipping more complicated each time the number of times of skipping the viewing of the image information increases or a method of displaying the selection screen of the image information when the user tries to bring the terminal into the sleep state can be employed, for example.

In one embodiment of the present invention, whether or not the aforementioned configuration of managing the viewing history of the videos is employed, the system may have a delivery server connected to the network and providing predetermined types of delivered information is further provided. The management server may comprise: (a) a viewing history management unit for managing the viewing history of the delivered information by the terminal; and (b) a privilege management unit for determining a privilege given to the user of the terminal on the basis of the viewing history.

As the delivered information from the delivery server, various contents such as advertisements, news, weather forecasts, tourist information, fortune telling, event information and the like can be used. The delivered information may be videos or still images. The delivered information may also serve as the image information displayed after the video described above is played back.

For the delivered information, methods such as viewing of a web page using a browser, displaying of an e-mail including the delivered information and the like can be employed, for example. The delivered information may take a form of display with other types of information at a part of the web page, for example.

The viewing history management unit of the management server integrates and manages the history of viewing the delivered information at the terminal. The viewing history management unit may be configured to have both functions of management of the viewing history of the videos described above and of management of the viewing history of the delivered information or may include only a management function of the viewing history of the delivered information.

The privilege management unit determines a privilege given to the user on the basis of the viewing history. The privilege can be determined on the basis of both the viewing history of the videos and the viewing history of the delivered information. For example, such a method can be employed that the respective viewing histories are converted to unified points on the basis of the number of viewed images, time and the like and the privilege is determined on the basis of the points. Moreover, the privilege may be determined by individually evaluating the viewing history of the videos and the delivered information. In this case, the type of the privilege may be made different in both, for example a usage fee is discounted on the basis of the viewing history of the videos, and a coupon is provided on the basis of the delivered information.

According to the aforementioned mode, since the privilege is given on the basis of the delivered information, it makes motivation for viewing the delivered information, which prompts the user to view the delivered information more easily.

When the viewing history of the delivered information is to be managed, the viewing history management unit may obtain a viewing history managed by the delivery server among the viewing histories of the delivered information by the terminal from the delivery server.

Some of the delivery servers manage the viewing history and the like by applying identification information, that is, a user ID to the user as in various portal sites in order to realize provision of information along preferences of the user. In the mode as above, since the viewing history managed by such delivery servers can be obtained, the viewing history can be managed easily unless the management server itself minutely manages the viewing history of the information delivered by utilizing the terminal.

A method and timing of obtaining the viewing history from the delivery server can take various modes. For example a report may be made from the delivery server to the management server periodically or when a data amount of the viewing history reaches a predetermined value. Alternatively, the management server may query about the viewing history at the delivery server.

However, the management of the viewing history is not limited to the mode using the delivery server. For example, a function of accumulating the viewing histories of the delivered information may be provided in the terminal in a form of an application or the like and the accumulated viewing histories are reported to the management server. Alternatively, a method of accumulating a delivery history in the terminal and a method of using the delivery server may be used in combination. In this case, since there is a concern that both methods accumulate the viewing histories in duplication, the management server is preferably provided with a history organizing function which deletes one of the duplicated viewing histories, or the like.

Moreover, in order to enable obtainment of the viewing history from the delivery server, the viewing history management unit may manage the viewing history in association with terminal identification information for specifying the terminal. The delivery server may comprise: (a) a user database for storing the viewing history in association with user identification information for the user of the terminal; and (b) a registration assist unit which, when a predetermined registration operation for viewing the delivered information is performed by the terminal, obtains the terminal identification information of the terminal in accordance with the registration operation and reports it in association with the user identification information to the management server. The viewing history management unit may obtain the viewing history from the delivery server by using the user identification information associated with the terminal identification information.

In order to obtain the viewing history from the delivery server, the user identification information used by the delivery server for managing the user and the terminal identification information used by the management server for managing the terminal or the user need to be associated with each other. A method of such association can include a method of registration of the delivery server and the user identification information by the user in the management server, or in an opposite manner, a method of registration of the management server and the terminal identification information in the delivery server but both of them are cumbersome.

On the other hand, according to the mode described above, by performing a registration operation for viewing the delivered information from the delivery server by using the terminal, the delivery server side can obtain the terminal identification information and report it in association with the user identification information to the management server. Since the terminal identification information can be included in the information transmitted to the delivery server during the registration operation, the delivery server only needs to analyze it and obtain it. As a result, only by making an access to the delivery server by using the user identification information, the registration in the management server can be automatically completed, whereby convenience can be improved.

In accordance with one embodiment of the present invention, there is no need to include all the aforementioned various features but some of them can be omitted or combined as appropriate in configuration.

One embodiment of the present invention can be configured in various modes regardless of the mode as the aforementioned information provision system. For example, one embodiment of the present invention may be configured as the terminal or the portable terminal used in the aforementioned information provision system. Moreover, in the information provision system consisting of the aforementioned portable terminal and the management server, one embodiment of the present invention may be configured as a method of providing information by using the terminal and the management server. Furthermore, one embodiment of the present invention may be configured as a computer program for realizing each of the aforementioned functions on the terminal and the management server or may be configured as a computer-readable recording medium recording the computer program.

### BRIEF DESCRIPTION OF THE DRAWINGS

FIG. 1 is an explanatory diagram illustrating entire configuration of an information provision system.

FIG. 2 is an explanatory diagram illustrating internal configuration of the information provision system.

FIG. 3 is an explanatory diagram illustrating a configuration of user databases in a management server and an advertisement server.

FIG. 4 is a flowchart of registration processing of the advertisement server.

FIG. 5 is a flowchart of video playback processing.

FIG. 6 is a flowchart of video management processing.

FIG. 7 is a flowchart of advertisement display history recording processing.

FIG. 8 is a flowchart of viewing result tabulation processing.

FIG. 9 is a flowchart of video playback processing as a variation.

### DESCRIPTION OF EMBODIMENTS

### Embodiment 1

### A. System Configuration:

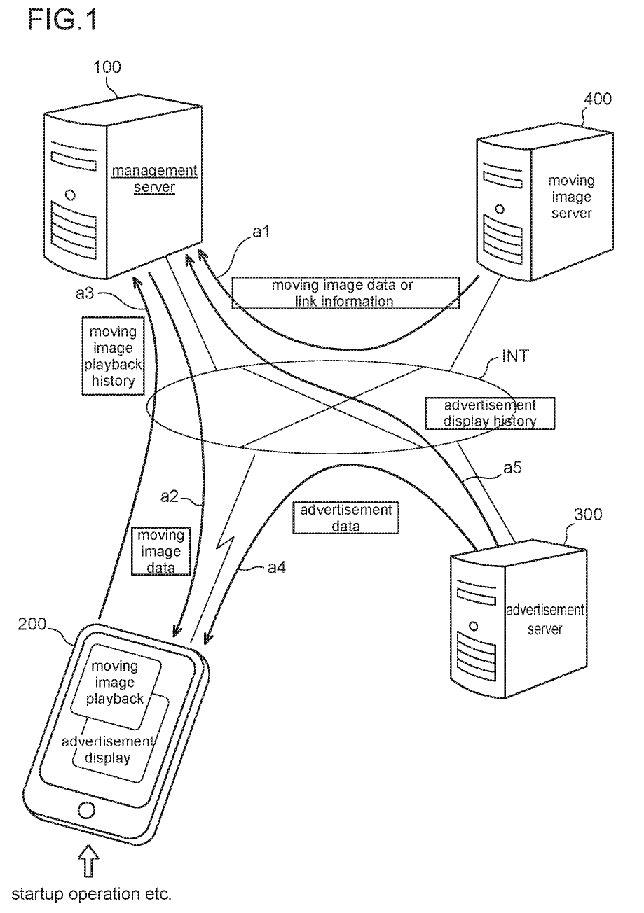

FIG. 1 is an explanatory diagram illustrating entire configuration of an information provision system. The information provision system is a system for managing various types of advertisement information provided from the video server 400, an advertisement server 300 by a management server 100 and for delivering them to a portable terminal 200 used by a user. The management server 100, the portable terminal 200, the video server 400, and the advertisement server 300 are connected via an internet INT, respectively. In this embodiment, delivery to the portable terminal 200 is exemplified, but a terminal used by the user is not limited to the portable terminal 200, but various devices connectable to the network INT such as a personal computer or a display device provided in a home electric appliance and the like can be used.

The management server 100 manages a result that the user viewed the advertisement information and can give a privilege such as a discount, exemption or the like of a usage fee in accordance with the result. The video server 400 and the advertisement server 300 are web servers for storing data such as a web page, respectively. Only one video server 400 and one advertisement server 300 are illustrated, but the number of units may be 2 or more or they may be integrated into the management server 100.

In this Specification, regarding the advertisement information provided in this embodiment, those provided from the video server 400 are called a “video” and those provided from the advertisement server 300 (may include both a still image and a video) as an “advertisement” for convenience of explanation.

In the figure, a flow of the information exchanged in the information provision system is illustrated.

First, the video server 400 registers video data or link information in the management server 100 (arrow a1). A procedure of registration is as follows, for example. When a business enterprise or the like using the video server 400 wants to use the information provision system of the embodiment, it makes an application for a use to an operator of the information provision system. Contents of a contract in the application for a use include an agreement on a usage fee. The usage fee may be a fixed amount or may be such that the more the result of viewing of the video by the user increases, the higher the usage fee rises. When the application for a use is approved, the business enterprise or the like registers the video to be delivered to the user in the management server 100 via the information provision system. The video data itself may be uploaded to the management server 100 or information indicating a location of the video data stored in the video server 400, e.g. an URL or the like, may be notified to the management server 100. The management server 100 stores the registered video data and the like as a database.

Subsequently, the user using the information provision system uses the portable terminal 200. The portable terminal 200 incorporates a function of obtaining the video data from the management server 100 as appropriate while being connected to the internet INT (arrow a2). When the video data is stored in the management server 100, the portable terminal 200 directly downloads it. When an URL of the video data is stored, the portable terminal 200 makes an access to the video server 400 in accordance with the URL to download the video data.

When the user applies a startup operation to the portable terminal 200, that is, an operation of activating from a sleep state, the portable terminal 200 plays back the video data which has been downloaded. The playback of the video is performed automatically in accordance with the startup operation even if the user does not perform an individual operation for playback of the video. A result of viewing of the video by the user is reported to the management server 100 as a video generation history (arrow a3) and is utilized for privileges such as a discount of a usage fee and the like of the portable terminal.

When the user performs the startup operation, it means that the user is to use the portable terminal 200 and thus, it is likely that the user views the video played back at that time unexpectedly. Therefore, it becomes possible for the business enterprise to efficiently provide an advertisement using the video to the user. Moreover, the results of viewing of the videos increases, the user can receive the privileges such as a discount of a usage fee of the portable terminal, and thus, viewing of the videos is beneficial also for the user. If the operator of the information provision system has more results of viewing of the videos, even if the usage fee of the portable terminal is discounted, the operator can obtain profits by increasing the usage fees from the business entities and the like for that portion.

The information provision system allows viewing of not only the videos but also of advertisements. In this embodiment, servers operating various portal sites including a search engine and the like, for example, can be used as the advertisement server 300. It is needless to say that the advertisement server 300 is not limited to the portal site but may be web servers providing web pages of the business entities and the like.

The advertisement server 300 providing a portal site provides a function of a search engine and the like on the web page and provides various news and advertisements and the like. The user can view the information by using these functions by making an access to the portal site (arrow a4). Moreover, the portal site gives a user ID to the user for enabling information provision according to the preference of the user and manages the advertisements and the like viewed by each of the users as advertisement display histories. The advertisement server 300 reports the advertisement display history of the user to the management server 100 (arrow a5). The management server 100 utilizes it for the privileges to the user on the basis of the reported advertisement display history similarly to the viewing history of the videos.

In the information provision system, the advertisement is not automatically displayed as the video but is displayed by a user's click of a link of the advertisement on the portal site and the like. However, in this embodiment, since the privilege can be obtained also by viewing the advertisement similarly to the video, it makes motivation for the user to view the advertisement, and a possibility that the advertisement is viewed can be increased. If the possibility of viewing the advertisement increases, a use value of the information provision system improves for the operator of the advertisement server 300. Therefore, the user of the information provision system can obtain profits by increasing the usage fee from the advertisement server 300.

FIG. 1 illustrates the example in which the advertisement server 300 manages the display history of the advertisement and reports it to the management server 100 but this is not limiting. For example, the portable terminal 200 may be given a function of accumulating the viewing history of the advertisement and of reporting it to the management server 100. Moreover, the management of the history by the portable terminal 200 and the management by the advertisement server 300 may be used in combination.

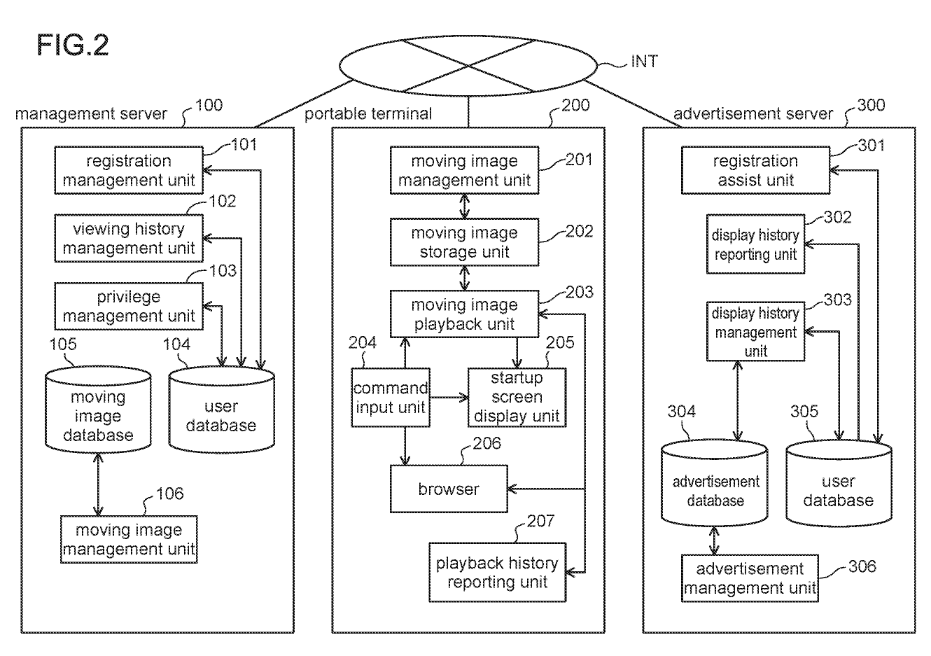

FIG. 2 is an explanatory diagram illustrating internal configuration of the information provision system. Functional blocks which should be included in each device in order to realize the function explained in FIG. 1 are illustrated. In this embodiment, the portable terminal 200, the management server 100, the advertisement server 300, and the video server 400 are all computers each including a CPU, a RAM, a ROM and the like and thus, each of the functional blocks is assumed to be configured in a software manner by installing computer programs for realizing the respective functions mainly in the computers but any one of them can be also configured in a hardware manner.

Configuration of the management server 100 will be described. The management server 100 includes two databases, that is, a user database 104 and a video database 105. The user database 104 is a database for storing various types of information relating to a user using the information provision system. The stored data includes a viewing history of the videos, advertisements and the like and information relating to the privileges given on the basis of the viewing history in addition to basic information such as a name, a terminal ID of the terminal in use and the like. The video database 105 stores the video data to be delivered to the portable terminal 200 or its link information. This embodiment is configured capable of storing the both in a mixed manner.

A video management unit 106 manages the video database 105. It receives an upload of the video data, link information and the like from the video server 400 (not shown) and stores them in the video database 105. Moreover, it delivers the video data in response to a request from the portable terminal 200. The video may be delivered simply from the older ones stored in the video database 105 or those matching the preference of the user or like of the user may be delivered with priority. Various known methods can be applied as a method of analyzing such preferences.

A registration management unit 101 manages registration information in the user database 104. As described in FIG. 1, the information provision system has a function of managing the advertisement display history by the advertisement server 300 and of reporting it to the management server 100. Here, the advertisement server 300 manages each of the users by using the user IDs specific to the portal site or the like operated therein and thus, in order for the management server 100 to utilize the advertisement display history accumulated in the advertisement server 300, the user ID needs to be registered in the management server 100 in advance. The registration management unit 101 also exerts a function of obtaining the information such as the user ID from the advertisement server 300 and of registering it in the user database 104.

The viewing history management unit 102 exerts a function of managing the viewing histories of the videos, advertisements and the like. Regarding the videos, the history reported from the portable terminal 200 is obtained and stored in the user database 104. Regarding the advertisements, the advertisement display history is obtained from the advertisement server 300 and stored in the user database 104. The viewing history management unit 102 also exerts a function of deleting one of duplicated viewing histories so as to organize the histories.

A privilege management unit 103 exerts a function of determining a privilege to the user on the basis of the viewing history. In this embodiment, since the viewing histories of the videos and the advertisements are mixed, the privilege management unit 103 is configured to convert the both to common points by a predetermined evaluation method and to determine the privilege according to the points. Contents of the privileges can include provision of a complimentary coupon which can be used in various online shops and the like, reduction of the usage fee of the portable terminal 200 and the like. The viewing histories of the videos and the advertisements may be separately managed, and the privilege based on the viewing history of the videos and the privilege based on the viewing history of the advertisements may be separated and determined.

Configuration of the portable terminal 200 will be described. A terminal ID for identifying the terminal is given to the portable terminal 200.

A command input unit 204 inputs a command by an operation by the user via a screen of the portable terminal 200 or various physical switches and the like.

A startup screen display unit 205 exerts a function of the OS of the portable terminal 200 which is a function of displaying a startup screen on which icons and the like for starting up various applications are arrayed after the startup from the sleep state.

A video management unit 201 obtains the video data for playback from the management server 100. The obtained video data is stored in a video storage unit 202. Although the video storage unit 202 may store only one piece of the video data, the video storage unit 202 in this embodiment is configured to be capable of storing plural pieces of the video data.

A video playback unit 203 plays back a video by using the video data stored in the video storage unit 202. In this embodiment, when the fact that the startup operation for starting the portable terminal 200 from the sleep state has been performed is detected, the video playback unit 203 stops display of the startup screen by the startup screen display unit 205 once and performs playback of the video. When the playback of the video is completed, the operation of the startup screen display unit 205 is resumed. By configuring as above, at startup from the sleep state, the video stored in advance is played back and then, the startup screen is displayed. In this embodiment, the video playback unit 203 is configured in the software manner but is protected so as not to be deleted or the like by an operation by the user. That is, it is excluded from targets that can be uninstalled by a normal operation and when it is to be uninstalled, an input of a special password is required.

A browser 206 is an application for viewing a web page. In this embodiment, it is used for viewing the advertisement.

A playback history reporting unit 207 accumulates playback histories of the videos and reports them at appropriate timing to the management server 100. The report of the history can be performed at various timings. For example, the report of the history may be made by making an access to the management server 100 from the portable terminal 200 immediately after the video is viewed, or at a point of time when the viewing histories of the videos are accumulated to a predetermined amount, certain timing set in advance and the like. Alternatively, the management server 100 may make an access to the portable terminal 200 as appropriate to request the report of the history. Other than the above, the portable terminal 200 may report the history at the same time as it downloads the video data from the management server 100.

Configuration of the advertisement server 300 will be described. The advertisement server 300 includes two databases, that is, a user database 305 and an advertisement database 304. The user database 305 is a database for storing information as members using the advertisement server 300. The stored data also includes the viewing history of the advertisements and the like in addition to the basic information such as a name or a user ID. The advertisement database 304 stores advertisement data to be delivered to the portable terminal 200. There are both still images and videos in the advertisement data.

An advertisement management unit 306 accepts advertisement data from the business entities and the like and stores it in the advertisement database 304. Moreover, it also exerts a function of selecting and delivering the advertisement according to the preference of the user from the advertisement database 304 when the user requests viewing of the advertisement.

When the user views the advertisement, a display history management unit 303 stores its history in the user database 305.

A registration assist unit 301 exerts a function of assisting registration of the user ID as a member of the advertisement server 300 in the management server 100. In this embodiment, the management server 100 manages a viewing history and the like by using the terminal ID of the portable terminal 200. The registration assist unit 301 obtains the terminal ID from the portable terminal 200, associates it with the user ID and transmits it to the management server 100.

A display history reporting unit 302 exerts a function of reporting an advertisement display history managed by the advertisement server 300 to the management server 100. In the advertisement server 300, the display history is managed in association with the user ID, but since the user ID is registered in the management server 100 by the function of the registration assist unit 301, the management server 100 can associate the reported display history with the user.

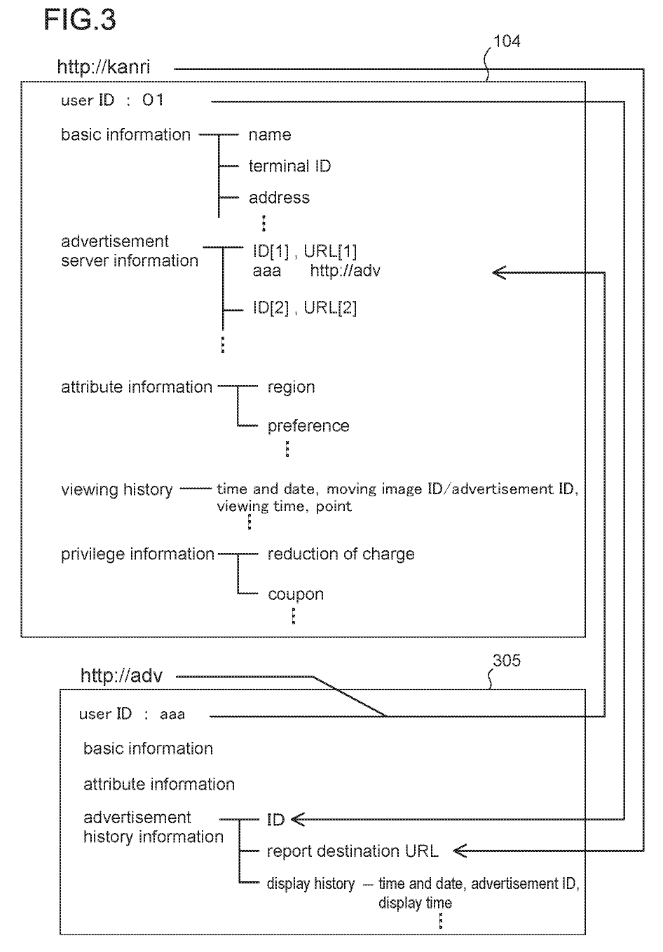

FIG. 3 is an explanatory diagram illustrating configuration of the user database in the management server and the advertisement server. The configuration of the user database 104 of the management server 100 is illustrated on an upper side, while the configuration of the user database 305 in the advertisement server 300 is illustrated on a lower side.

The user database 104 of the management server 100 stores the basic information, advertisement server information, attribute information, viewing histories, privilege information and the like in addition to the user ID for identifying each of the users. The basic information is personal information of the user such as a name, a terminal ID, an address and the like.

As the advertisement server information, a plurality of types of information of the advertisement server 300 used by the user is stored. In this embodiment, the user ID (ID[1], ID[2] . . .) when the respective advertisement servers 300 are used and the link information (URL[1], URL[2] . . .) of the advertisement server 300 are stored. In the example in the figure, the user ID [aaa] given to the user in the advertisement server 300 illustrated on the lower side and the information of the URL [http://adv] of the advertisement server 300 are associated with each other and stored.

As the attribute information, information such as a region, a preference registered by the user is stored. This information is used for delivering the video according to the preference of the user and the like.

As the viewing history, a history of viewing of the videos or advertisement by the user is stored. The information indicating the history includes time and date of viewing, a video ID for identifying the viewed video or advertisement ID, time required for the viewing (viewing time), points and the like. The point is an evaluation value calculated by a predetermined conversion equation for evaluating the viewing results of the videos and advertisements in a unified manner on the basis of the viewing time and the like.

The privilege information stores privileges given to the user on the basis of the viewing history. Contents of the privileges include reduction of charges to the portable terminal 200, or provision of coupons and the like.

The user database 305 of the advertisement server 300 stores the basic information, the attribute information, the advertisement history information and the like in addition to the user ID for identifying each of the users. The user ID is not the identification information for using the information provision system but identification information as a member of the advertisement server 300. This information is registered in the user database 104 of the management server 100 together with the URL of the advertisement server 300 as described above.

The basic information is personal information such as a name of the user, and the attribute information is information indicating the preference of the user and the like.

As the advertisement history information, information on a destination to report the advertisement history and the link information (report destination URL) of the management server 100 are stored. In this embodiment, the URL of the management server 100 “http://kanri” is stored. In addition, the user ID used in the management server 100, that is, the information “01” in the example of the figure is also stored, but this user ID may be omitted. That is because, when the advertisement server 300 transmits a history together with the user ID “aaa” for the advertisement server 300, the management server 100 can specify the user to which the history belongs by referring to the advertisement server information of the user database 104.

As the advertisement history, the display history that the user allows the advertisement to be displayed is also stored. The display history includes information such as time and date when the advertisement is displayed, an advertisement ID for identifying the advertisement, display time.

By means of the system configuration as above, the information provision system realizes the various functions explained in FIG. 1.

Processing contents for realizing the respective functions will be described below on the basis of flowcharts.

### B. Registration Processing:

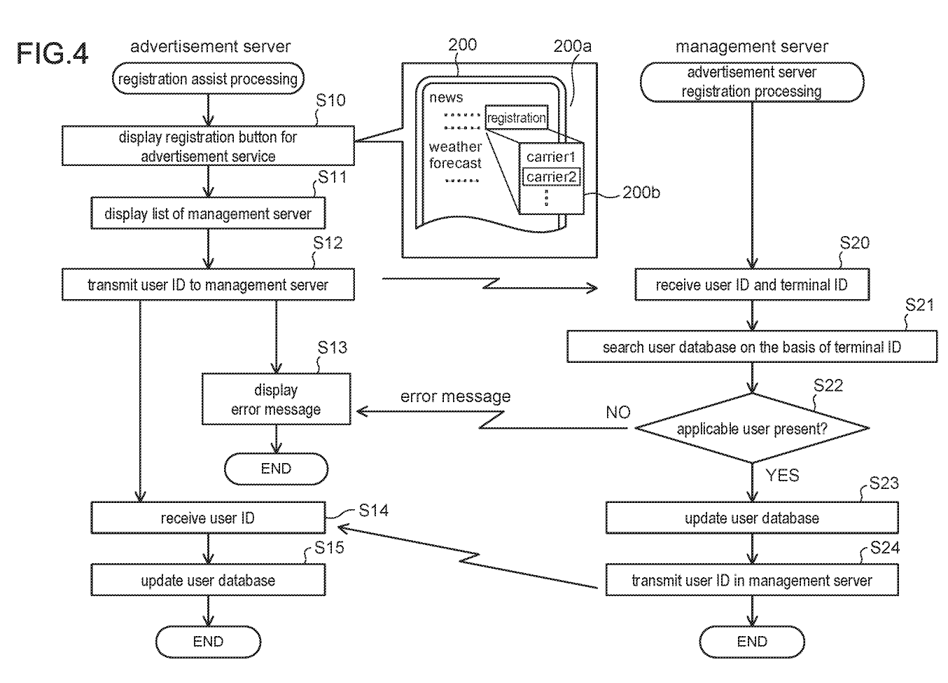

FIG. 4 is a flowchart of registration processing of the advertisement server. It is processing by the advertisement server 300 for registering the user ID in the management server. Processing executed in the advertisement server 300, that is, a flow of registration assist processing is illustrated on the left side, while processing executed in the management server 100, that is, a flow of advertisement server registration processing is illustrated on the right side.

This processing is executed in a state where the user operates the portable terminal 200 so as to allow a portal site and the like provided by the advertisement server 300 to be displayed and makes a login by inputting a user ID or the like for using the site.

First, the advertisement server 300 displays a registration button for using advertisement service by the information provision system (Step S10). An example of a display screen in the portable terminal 200 is illustrated on the right side in the figure. When the portal site or the like provided by the advertisement server 300 is displayed, the registration button 200a for using the advertisement service is displayed together with information such as news or weather forecast. When the user wants to receive a service by the information provision system, that is, a service to receive a privilege by viewing the advertisement on the portable terminal 200, the user only needs to click this registration button 200a.

When the registration button 200a is clicked, the advertisement server 300 displays a list of the management servers (Step S11). In this embodiment, the management server 100 is configured to be provided at each of carriers of the portable terminals 200, that is, each communication carrier. Therefore, as illustrated in a screen example on the right side, the list of the management servers is displayed as a pull-down list 200b of carrier names The user only needs to select the carrier the user uses. The example in the figure illustrates that the “carrier 2” is selected. When the carrier is selected, the link information (URL) of the management server 100 associated with that is specified.

The advertisement server 300 transmits the user ID for identifying the user in the advertisement server 300 to the specified management server 100 (Step S12). Since the advertisement server 300 has received information such as a click of the registration button and selection of the carrier from the portable terminal 200, it can also obtain the identification information (terminal ID) of the portable terminal 200 in this process. To the management server 100, this terminal ID is also transmitted together with the user ID.

When the management server 100 receives the user ID and the terminal ID from the advertisement server 300 (Step S20), it searches the user database 104 on the basis of the terminal ID (Step S21). If there is no applicable user, the user ID cannot be registered. Therefore, the management server 100 transmits an error message to the advertisement server 300 (Step S22). The advertisement server 300 displays this error message on the screen of the portable terminal 200 (Step S13) and finishes the registration assist processing. Such an error is considered to be caused by a wrong selection of the carrier by the user and thus, the user only needs to click the registration button 200a and to select the carrier from the list 200b again.

When there is an applicable user as the result of the search (Step S22), the management server 100 updates the user database 104 (Step S23). That is, the user ID transmitted from the advertisement server 300 and the URL of the advertisement server 300 are registered in the advertisement server information of the user database 104. If there is an existing user ID for the same advertisement server 300, the portable terminal 200 may be asked whether or not the prior user ID may be erased via the advertisement server 300.

After updating the user database 104, the management server 100 transmits the user ID used for specifying the user in the management server 100 (“01” in FIG. 3) to the advertisement server 300 (Step S24) and finishes the advertisement server registration processing.

The advertisement server 300 receives this user ID (Step S14), updates the user database 305, that is, registers it in the “ID” of the advertisement history information (see FIG. 3) (Step S15), and finishes the registration assist processing.

By means of the processing as above, the advertisement server 300 as a target of the information provision system and the user ID used therein are registered in the management server 100, while the location of the management server 100 to which the display history should be reported is registered in the advertisement server 300, whereby mutual transaction of the information such as the display history and the like is enabled.

### C. Video Playback Processing:

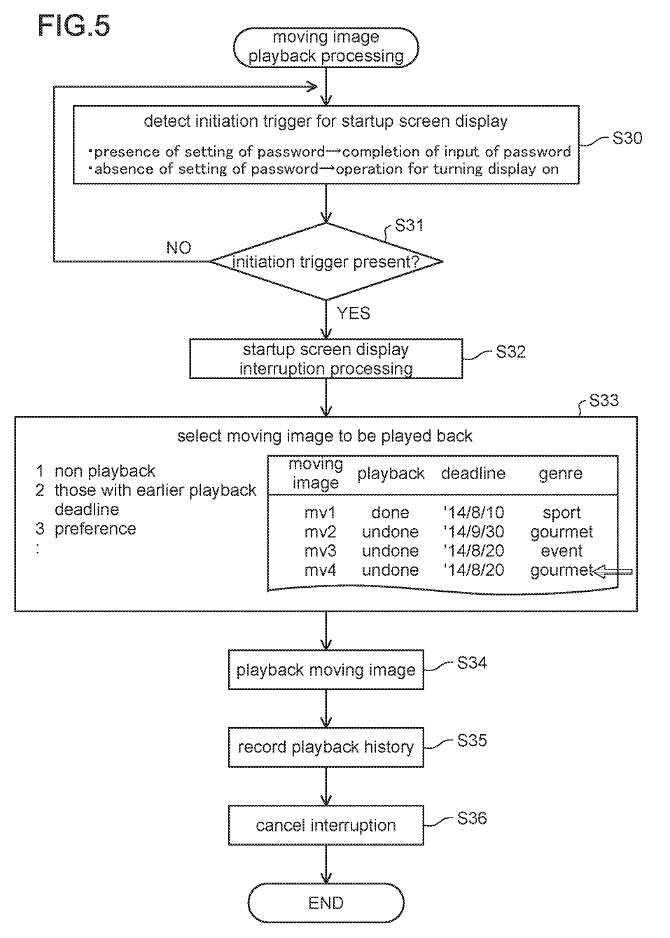

FIG. 5 is a flowchart of the video playback processing. This is the processing executed when the startup operation is performed from the sleep state in the portable terminal 200.

The portable terminal 200 returns from the sleep state and detects an initiation trigger for initiating the startup screen display (Step S30). The startup screen refers to a screen indicating that the portable terminal 200 can be now used for various applications such as a screen on which icons for starting an application are arrayed. For example, if a password is set, the portable terminal is made usable only after the password or the like is input and thus, an input screen of the password or the like does not fall under the startup screen. A screen displayed after the input of the password or the like falls under the startup screen.

Therefore, the initiation trigger differs depending on presence of setting of the password. When the password is set in the portable terminal, completion of the input of the password or the like becomes the initiation trigger. If the password is not set, various operations for turning the display on, that is, an operation of any one of physical switches, for example, becomes the initiation trigger.

When the portable terminal 200 detects the initiation trigger (Step S31), it performs startup screen display interruption processing, that is, processing of interrupting the processing of displaying the startup screen and of stopping the processing (Step S32).

Then, the video to be played back is selected (Step S33). The video may be simply selected from those with older timing of being stored in the portable terminal 200 or may be selected at random, but in this embodiment, the selection is made on the basis of the following three preference conditions:

The first condition is a video which has not been played back. That is because, by playing back the video which has not been viewed by the user yet, distraction of the user can be suppressed.

The second condition is “those with earlier playback deadline”. In some of the videos such as the weather forecast, fortune telling, advertisements of an event or a campaign with limited time and date and the like, meaning of the information is substantially lost after expiration of the certain playback deadline. By playing back the video with the earlier playback deadline with priority, discarding of these videos without having been played back can be avoided.

The third condition is a preference of the user. By playing back the video relating to sports in preference to the user who likes sports, the user's interest can be attracted, for example.

An example of selecting the video is illustrated in the figure. It is assumed that four videos mv1 to mv4 are stored in the portable terminal 200, for example. The video mv1 has been already played back, while the videos mv2 to mv4 have not been played back yet. Therefore, the portable terminal 200 selects the videos mv2 to mv4 with priority on the basis of the first condition. Subsequently, by referring to the respective deadlines, the playback deadline of the video mv2 is Sep. 30, 2014, while the playback deadlines of the videos mv3 and mv4 are as early as Aug. 20, 2014. Therefore, the portable terminal 200 gives priority to the videos mv3 and mv4. Moreover, on the basis of the condition 3, if the user tends to prefer gourmet to events, for example, the video mv4 is selected.

By selecting the video on the basis of the conditions 1 to 3 as above, information which does not tire the user but is meaningful and interesting can be provided to the user.

There is no need to consider all the conditions 1 to 3 for selecting the video, but some of them may be omitted. Moreover, conditions other than them may be added. If playback time differs among the videos, for example, a length of the playback time can be also considered as a condition for selecting the video.

When the video is selected, the portable terminal 200 plays back the selected video (Step S34) and records the playback history (Step S35). The playback history can include information such as time and date of the playback, the video ID for specifying the played-back video, playback time and the like.

When the playback of the video is completed, the portable terminal 200 cancels the interruption processing of the startup screen display (Step S36) and finishes the video playback processing. By cancelling the interruption, the startup screen is displayed on the portable terminal 200, and the user can now use the portable terminal.

In this embodiment, the example in which the video is played back after the startup screen display is stopped once, but the video may be played back on its front surface while the startup screen is displayed. That is, the video may be played back in a state where, although the startup screen is displayed in processing, it is hidden by the video so that the user cannot see or operate.

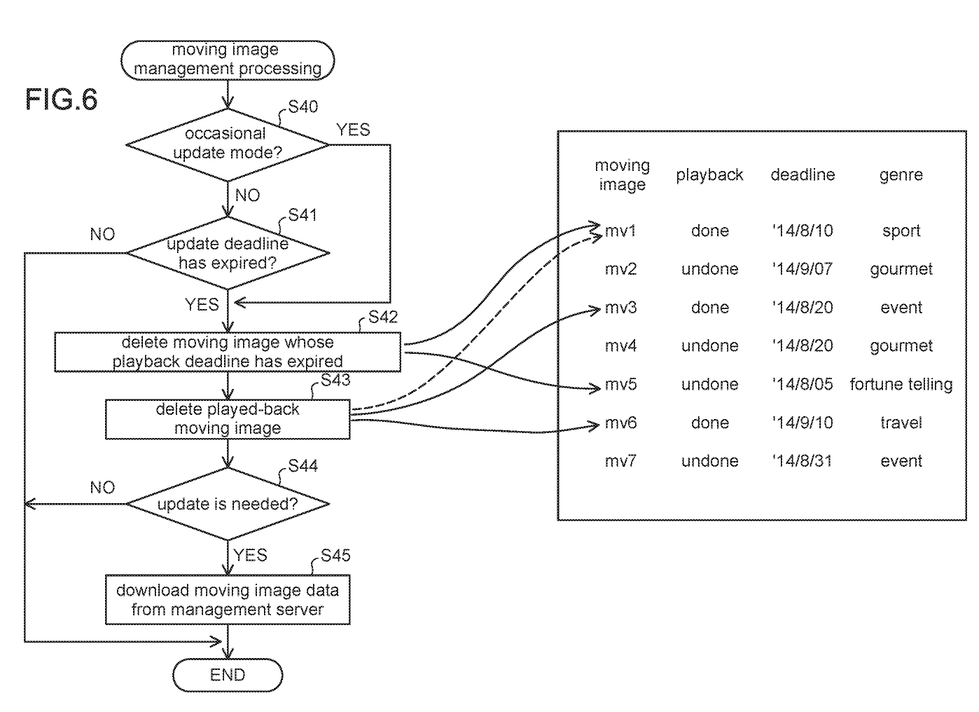

FIG. 6 is a flowchart of video management processing. This is the processing for the portable terminal 200 to download the video data from the management server 100. In this embodiment, it is so configured that the user can make selection from two modes, that is, a mode of periodically updating the video data and a mode of update at any time.

When the portable terminal 200 initiates the video management processing, it determines whether an occasional update mode is selected or not (Step S40). If it is not in the occasional update mode, that is, when the periodic update mode is selected, it is determined whether an update deadline has expired or not (Step S41), and if the update deadline has not expired, the video management processing is finished as it is.

When the occasional update mode is selected (Step S40) or when the update deadline has expired in the periodic update mode (Step S41), the video is updated by the following procedure.

First, the video whose playback deadline has expired is deleted (Step S42). A state of the processing when the video is updated is illustrated on the right side. It is assumed that the portable terminal 200 stores 7 videos mv1 to mv7. Assuming that a date when the video management processing is executed is Aug. 12, 2014, the playback deadlines of the videos mv1 and mv5 expire on Aug. 10, 2014 (mv1) and Aug. 5, 2014 (mv5), respectively. Therefore, their playback deadlines have both expired. Accordingly, at Step S42, the videos of the videos mv1 and mv5 are deleted.

Subsequently, the portable terminal 200 deletes the played-back video (Step S43). In the example on the right side, the videos which have been played back are videos mv1, mv3, and mv6. Since the video mv1 has been already deleted at Step S42, the remaining videos mv3 and mv6 are deleted by the processing at Step S43.

The portable terminal 200 subsequently determines whether update of the video is needed or not (Step S44). If no video has been deleted by the processing at step S42 and S43, for example, it is determined that a need to obtain a new video is low, and the video management processing is finished without updating the video. If the video has been deleted by the processing at Steps S42 and S43, videos as many as the number of the shortage by deletion are downloaded from the management server (Step S45). In the example illustrated on the right side, since four videos have been deleted, four pieces of video data are newly downloaded from the management server 100. The video to be downloaded is preferably selected by considering the user's preference.

In this example, the case in which seven videos have been stored in the portable terminal 200 is used as an example and explained, but the number of videos that can be stored can be arbitrarily set. Moreover, the maximum number of videos that can be stored do not necessarily have to be maintained. For example, if the video matching the user's preference has not been uploaded in the management server 100, even though the four videos are deleted, the number of videos to be downloaded may be kept to 1 to 3. To the contrary, the number of pieces of new video data matching the user's preference is checked from the management server 100, and deletion of the videos by the processing at Steps S42 and S43 may be limited to that number as an upper limit.

### D. Advertisement Display History Recording Processing:

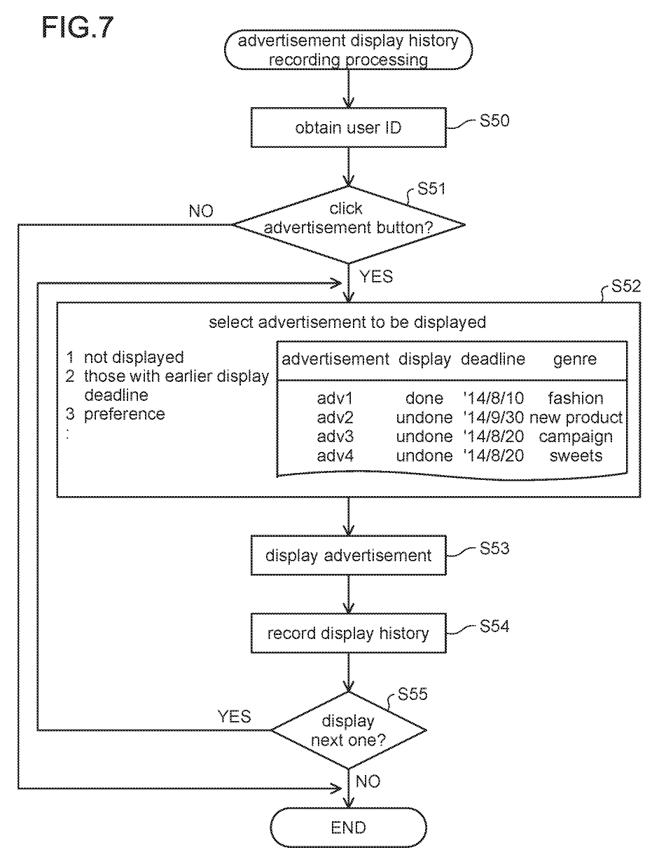

FIG. 7 is a flowchart of advertisement display history recording processing. This is the processing of the advertisement server 300 for recording the display history of the advertisements by the user.

When the user logs into the portal site or the like provided by the advertisement server 300, the advertisement server 300 obtains the user ID on the basis of its information (Step S50).

When the user closes the site without clicking the button of the advertisement (Step SM), the advertisement server 300 finishes the advertisement history recording processing without executing any processing.

If the user clicks the advertisement button (Step S51), the advertisement server 300 selects an advertisement to be displayed (Step S52). Conditions for selecting the advertisement is that the advertisement has not been displayed, the advertisement has an earlier display deadline, and the advertisement matches the user's preference similarly to the selection of the video. An example of advertisement selection is illustrated on the right side of the figure. Here, it is assumed that four advertisements can be selected. An advertisement adv1 has been already displayed and its priority is reduced in compliance with the first condition. According to the display deadline, advertisements adv3 and adv4 with the deadline of Aug. 20, 2014 are given priority over an advertisement adv2 with the deadline of Sep. 30, 2014. Then, either one is selected in accordance with the user's preference.

In the embodiment, the example in which the advertisement is selected by the advertisement server 300 is illustrated, but banners of the respective advertisements may be displayed on the web page so that the user can select the advertisement in which the user is interested by himself/herself.

When the advertisement is selected, the advertisement server 300 displays the advertisement (Step S53). Then, it records its display history (Step S54). The display history can include information such as time and date when the advertisement is displayed, the advertisement ID for specifying the advertisement, time during which the advertisement is displayed and the like. These types of information are recorded in the user database 305 of the advertisement server 300 (see FIG. 3).

When the user designates the subsequent advertisement display (Step S55), the advertisement server 300 repeatedly executes processing at Steps S52 to S54 and displays new advertisements. When the subsequent advertisement display is not designated and end is instructed, the advertisement server 300 finishes display of the advertisement and also finishes recording of the history.

By means of this processing, the advertisement server 300 can record the history of display of the advertisements by the user.

In the embodiment, the example in which the advertisement server 300 records the advertisement display history is illustrated, but an application for displaying the advertisement and for recording the history may be installed in the portable terminal 200 so that the history is recorded by the portable terminal 200. Processing contents in this case are similar to those in the processing executed by the advertisement server 300 (FIG. 7). However, selection of the advertisement (Step S52 in FIG. 7) is preferably made not on the portable terminal 200 but on the advertisement server 300 side. Alternatively, this processing may be omitted.

### E. Viewing Result Tabulation Processing:

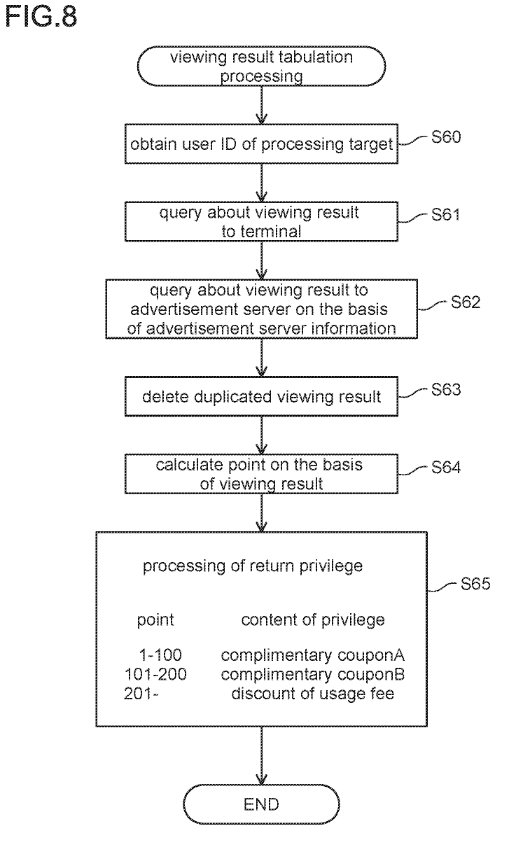

FIG. 8 is a flowchart of viewing result tabulation processing. This is the processing for tabulating viewing results of videos and advertisements to determine a privilege to be given to the user in the management server 100.

When this processing is initiated, the management server 100 determines a processing target and obtains its user ID (Step S60). The user ID is information used by the management server 100 for management of the user, that is, information which is indicated as “01” as the user ID in the example of FIG. 3.

Subsequently, the management server 100 queries the portable terminal 200 used by the user about the viewing result (Step S61). The playback history of the video is reported from the portable terminal 200.

The management server 100 also queries to the advertisement server 300 about the viewing result on the basis of the advertisement server information in the user database 104 (Step S62). When a plurality of the advertisement servers is registered, the management server 100 queries each of the advertisement servers sequentially. The display history of the advertisement is transmitted from the advertisement server 300 to the management server 100.

Subsequently, the management server 100 deletes the duplicated viewing results (Step S63). The duplicated viewing results refer to the histories having the same time and date of viewing and contents. The case where the same video or advertisement is repeatedly viewed is not treated to be the duplication. Such viewing histories of duplication occur when the portable terminal 200 and the advertisement server 300 report the viewing result having been reported to the management server 100 in duplication, respectively. Moreover, when the display history of the advertisement can be managed both by the portable terminal 200 and the advertisement server 300, the viewing results reported from the both can be duplicated.

When the viewing results are tabulated, then, the management server 100 calculates a point on the basis of the viewing results (Step S64). This point is an evaluation value used for handling the viewing results of the videos and advertisements in a unified manner and can be calculated by various methods shown below, for example:

Point=point of video×number of viewing times of video+point of advertisement×number of viewing times of advertisement; Calculation Method 1

Here, arbitrary values can be set to the points of the videos and the advertisements. However, while the video is played back regardless of intention of the user, considering the fact that the advertisement is displayed on the basis of intention of the user, the point of video<the point of advertisement is preferable.

Point=SUM (point of video×viewing time of video×coefficient of video)+SUM(point of advertisement×display time of advertisement); Calculation Method 2

Here, arbitrary values can be set to the point of video and the point of advertisement.

The coefficient of the video is a coefficient for adjusting weights of the viewing time of the video and the display time of the advertisement and can be set arbitrarily.

Considering that the video is played back for certain time regardless of intention of the user, the weight per unit time during which the video is viewed is considered to be lighter than the display time of the advertisement and thus, the coefficient of the video is preferably a real number smaller than 1.

SUM indicates that the sum of all the viewing histories of the videos and the advertisements is acquired.

Calculation of the points can be performed in various methods other than the above. Moreover, if the same video or advertisement is viewed a plurality of times, the point may be increased or decreased in accordance with the number of viewing times.

The management server 100 executes processing of returning the privilege to the user on the basis of the point obtained as above (Step S65). In this embodiment, in a range of 200 points or less, a complimentary coupon A or a complimentary coupon B is provided to the user in accordance with the point, while in the case of 201 points or more, the usage fee of the portable terminal 200 is discounted. The discount of the usage fee may be a certain amount or a certain rate, or a discount amount or a discount rate may be changed in accordance with the point. Moreover, the user can select whether the user receives the privilege or not.

In the embodiment, such a method is employed that the video and the advertisement are comprehensively evaluated and the privilege is returned, but the both may be individually evaluated and the privilege may be returned for each of them.

### F. Effects and Variations:

According to the information provision system in the embodiment described above, information can be provided effectively by the video at timing when the user of the portable terminal 200 performs the startup operation and gazes at the screen. Moreover, since this video is obtained from the management server 100 as appropriate, distraction of the user can be suppressed. Furthermore, since the management server 100 can give privileges to the user on the basis of the viewing history of the video or advertisement, motivation for the user to view the video or advertisement can be also given, whereby efficiency of the information provision can be further improved.

The present invention does not necessarily have to include all the various features in the embodiments described above but a part of them may be omitted or combined as appropriate. Moreover, the information provision system is not limited to the mode of this embodiment but can be realized in various modes described below:

(1) The terminal is not limited to that owned by the user. It may be an ATM installed in a financial institute such as a bank, for example. When usage of the ATM by users ceases for some time, the ATM automatically turns the screen dark and brings it to the sleep mode. When the ATM is used as the terminal of this embodiment, when the user wants to use the ATM in the sleep mode as above and performs a predetermined startup operation, a video having been downloaded in advance is played back. The startup operation in this case includes insertion of a cash card, a touch on the screen and the like. The video can use various contents such as a video for calling attention to prevent a fraudulent act, or CM, for example In the ATM, too, a privilege may be given to the user in a form of reduction of a fee, for example, when these videos are viewed.

(2) Other examples of the terminal may be devices having various setting screens such as a certificate photo taking machine, a photo seal machine, a car navigation device, OA equipment such as a facsimile and a copying machine. These devices are also configured as computers including a CPU, a RAM, a ROM and the like therein for display of the setting screen and the like and can be also connected to the network. When such a device is used as a terminal, it can be so configured that, when the user performs a startup operation for starting up the device from the sleep state such as insertion of a coin or a money bill, a touch on the screen, an operation of the start button or the like, for example, the video having been downloaded in advance is played back. By configuring as above, the video can be provided to the user at timing when these devices are to be used, and since the setting screen cannot be operated until the video is finished, a possibility that the video is viewed by the user increases. That is, an effect similar to that of this embodiment can be obtained. Moreover, since the downloaded video is provided instead of the video stored in advance like an operation method of the device, timely information can be provided.

(3) Moreover, a monitor screen provided at a seat of an aircraft, a monitor screen installed in a home electric appliance and the like may be made connectable to the network so as to be used as a terminal. The user can enjoy various functions by operating these screens. For example, on the monitor screen provided at the seat of an aircraft, various types of entertainment can be enjoyed during a flight. On the monitor installed in the home electric appliance such as a monitor installed in a microwave, for example, various recipes can be checked. For the other home electric appliances, too, the present invention can be used for information provision for effectively utilizing the home electric appliances by providing the monitor. In the case where these devices are used as terminals, when the user performs the startup operation, a video having been downloaded in advance is played back at timing when the monitor screen is to be used. Therefore, a possibility that the video is viewed by the user is improved similarly to the embodiment.

(4) Moreover, as an example of the portable terminal, a remote controller of a home electric appliance and the like may be used. A screen of such a degree that a video can be viewed can be provided on the remote controller, and a function of connection to the network can be provided in the remote controller itself or a function of connection to the network can be provided via the home electric appliance to be operated by the remote controller. When the remote controller is used as a terminal, when the user operates the remote controller in order to operate the home electric appliance, it is detected as a startup operation, and the video having been downloaded is played back. In this mode, too, the possibility that the video is viewed is improved similarly to the embodiment.

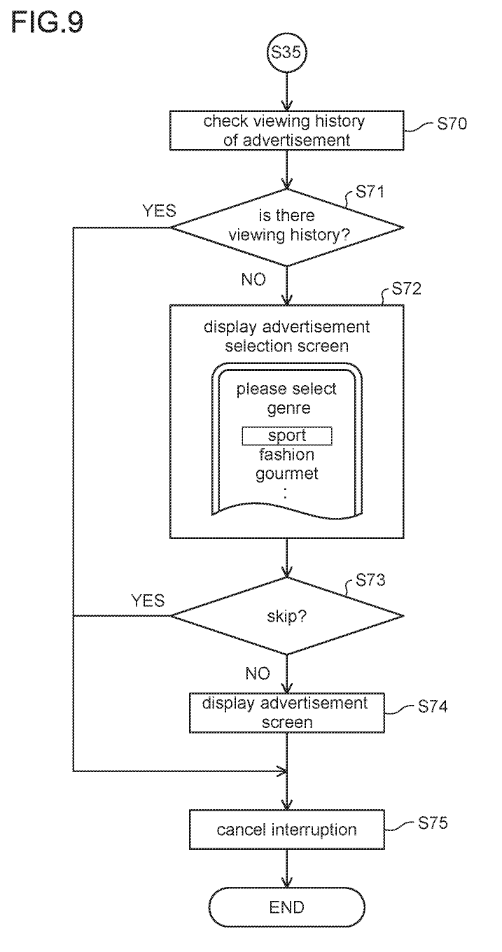

(5) A variation can be considered also for the video playback processing. FIG. 9 is a flowchart of the video playback processing as a variation. Processing contents further executed after Step S35 in the video playback processing described in the embodiment and before the interruption of the startup screen display is cancelled is illustrated.

When the video playback processing is finished, the terminal checks the viewing history of the advertisement (Step S71), and when there is no viewing history, the terminal displays an advertisement selection screen (Step S72). The advertisement viewing history is a history managed separately from the advertisement display history (see FIG. 7) and is a history indicating whether or not the advertisement has been viewed via the advertisement selection screen at Step S72. The detailed information illustrated in FIG. 7 may be managed as a history, or time and date when the advertisement was viewed last time may be simply managed, for example. Alternatively, whether the advertisement has been viewed or not may be indicated by a flag on a day when the terminal is being used.

An example of the advertisement selection screen is illustrated at Step S72. On this screen, a genre of the advertisement the user wants to view can be selected. The advertisements that can be displayed may also be displayed in a form of an icon or the like. Alternatively, it may be a screen on which whether or not the advertisement is to be displayed is simply selected. Such screens may be displayed by using an exclusive application or may be displayed by using a shortcut for starting up an application for displaying the advertisement such as a browser, for example.

The user may select the advertisement to be displayed on the advertisement selection screen or may skip the display of the advertisement by forcedly finishing this screen. When the display of the advertisement is not skipped (Step S73), the terminal displays the advertisement screen in accordance with the user's instruction (Step S74). The advertisement screen displayed here may be those downloaded from the network or may be those having been downloaded or the like in advance and stored in the terminal.

When the display of the advertisement screen is finished, the terminal cancels the interruption (Step S75) and displays the startup screen. When there is a viewing history (Step S71) or when the display of the advertisement screen is skipped (Step S73), interruption is cancelled (Step S75) and the startup screen is displayed similarly.

According to the processing of the variation as above, since the advertisement selection screen is displayed after the video is played back, motivation to view more diversified information can be given to the user. Since whether or not to display the advertisement screen is not compulsory but can be selected by the user (Step S73), impairment the convenience of the system can be also avoided.

Moreover, when there is a viewing history of an advertisement (Step S71), that is, if the user has the advertisement screen displayed even once in a day, the startup screen is displayed rapidly without displaying the advertisement selection screen (Step S71) and thus, motivation for the user to view the advertisement screen can be further strengthened.

Determination on whether or not to display the advertisement selection screen is not limited to a frequency of once a day but various periods or numbers of times can be set. Moreover, the periods or number may be changeable in accordance with the viewing history of other videos or other advertisement display history (see FIG. 8).

For the terminal of this embodiment, various variations can be considered as described above. Not limited to the aforementioned example, other various devices can be used as the terminals as long as they can be connected to the network.

The present invention can be used for providing advertisement information and other types of information to portable terminals such as a smart phone, a tablet, a mobile phone via a network.

What is claimed is:

1. An information provision system comprising a terminal used by a user and a management server for providing information to the terminal via a network, wherein:
the management server comprises
a video database for storing video data for providing the information in a video or access information for accessing the video data on the network; and
the terminal comprises:
a detecting unit for detecting a startup operation for starting up the terminal from a sleep state;
a video management unit for obtaining, prior to the startup operation, the video data in advance via the management server;
a video storage unit for storing the obtained video data;
a startup screen display unit for displaying a startup screen on the terminal in accordance with the startup operation; and
a video playback unit for playing back the video data stored in the video storage unit in preference to an operation of the startup screen display unit when the startup operation is detected.

2. The information provision system according to claim 1, wherein
the terminal is a portable terminal that can be carried by a user.

3. The information provision system according to claim 1, wherein
the video management unit obtains the video when at least one of conditions is satisfied that there is no more video data which has not been played back in the video data stored among the video storage unit and that there is no more video data within a view deadline.

4. The information provision system according to claim 1, wherein
the terminal comprises:
a playback history reporting unit for reporting a history of playback of the videos to the management server; and
the management server comprises:
a viewing history management unit for managing a viewing history of viewing the video by the terminal on the basis of the report; and
a privilege management unit for determining a privilege given to the user of the terminal on the basis of the viewing history.

5. The information provision system according to claim 1, wherein
the information provision system comprises a selection screen display unit for, after playback of video by the video playback unit is finished, displaying a selection screen prompting selection of display of image information different from the videos in preference to an operation of the startup screen display unit; and
an image information display unit for displaying the image information selected in the selection screen.

6. The information provision system according to claim 5, wherein
the selection screen display unit does not operate when a predetermined number which is one or more pieces of the image information is displayed within a predetermined period.

7. The information provision system according to claim 1, wherein
the information provision system has a delivery server connected to the network and providing predetermined types of delivered information is further provided; and
the management server comprises:
a viewing history management unit for managing the viewing history of the delivered information by the terminal; and
a privilege management unit for determining a privilege given to the user of the terminal on the basis of the viewing history.

8. The information provision system according to claim 7, wherein
the viewing history management unit obtains a viewing history managed by the delivery server among the viewing histories of the delivered information by the terminal from the delivery server.

9. The information provision system according to claim 8, wherein
the viewing history management unit manages the viewing history in association with terminal identification information for specifying the terminal, and
the delivery server comprises:
a user database for storing the viewing history in association with user identification information for the user of the terminal; and
a registration assist unit which, when a predetermined registration operation for viewing the delivered information is performed by the terminal, obtains the terminal identification information of the terminal in accordance with the registration operation and reports the terminal identification information in association with the user identification information to the management server, and
the viewing history management unit obtains the viewing history from the delivery server by using the user identification information associated with the terminal identification information.

10. A terminal for viewing information provided from a management server for providing information via network, comprising:
a detecting unit for detecting a startup operation for starting up the terminal from a sleep state;
a video management unit for obtaining, prior to the startup operation, the video data in advance via the management server;
a video storage unit for storing the obtained video data;
a startup screen display unit for displaying a startup screen on the terminal in accordance with the startup operation; and
a video playback unit for playing back the video data stored in the video storage unit in preference to an operation of the startup screen display unit when the startup operation is detected.

11. A method of providing information by using a terminal used by a user and a management server for providing the information to the terminal via a network, wherein:
the management server comprises a video database for storing video data for providing the information in a video or access information for accessing the video data on the network; and
the method comprises, on the terminal:
obtaining, prior to the startup operation, the video data in advance via the management server;
storing the obtained video data; detecting a startup operation for starting up the terminal from a sleep state; and
playing back the video data in preference to a process for displaying a startup screen on the terminal when the startup operation is detected.
